(19) United States
(12) Patent Application Publication
(10) Pub. No.: US 2018/0018692 A1
(43) Pub. Date: Jan. 18, 2018

(54) SYSTEM AND METHOD FOR ACQUIRING USERS

(71) Applicants: Michael R. Loeb, New York, NY (US); Dan McCabe, Wilton, CT (US); Steven Marcus, New Rochelle, NY (US); Andrew Bein, Riverside, CT (US)

(72) Inventors: Michael R. Loeb, New York, NY (US); Dan McCabe, Wilton, CT (US); Steven Marcus, New Rochelle, NY (US); Andrew Bein, Riverside, CT (US)

(21) Appl. No.: 15/641,816

(22) Filed: Jul. 5, 2017

Related U.S. Application Data
(60) Provisional application No. 62/361,722, filed on Jul. 13, 2016.

(51) Int. Cl. G06Q 30/02

(52) U.S. Cl. CPC G06Q 30/0239; G06Q 30/0236; G06Q 30/0222; G06Q 30/0225

(57) ABSTRACT

Provided are a system and method for acquiring users. In one example, the method includes providing a rebate offer with respect to a product, receiving, by an application server via the Internet, a request for payment of the rebate and proof of purchase of the product associated with the rebate via a mobile application executing on a mobile device, determining, by the application server, whether the mobile application executing on the mobile device corresponds to a new user of the mobile application, and in response to determining that the mobile application executing on the mobile device corresponds to a new user of the mobile application, authorizing payment of the rebate to a payment account previously registered through the mobile application executing on the mobile device.

### CROSS-REFERENCE TO RELATED APPLICATION(S)

This application claims the benefit under 35 USC §119(e) of US Provisional Patent Application No. 62/361,722, filed on Jul. 13, 2016, the entire disclosure of which is hereby incorporated by reference and for all purposes.

### BACKGROUND

Recently, there has been a dramatic growth in the amount of consumers downloading and using mobile applications and web applications. A mobile application is typically available for download through one or more application stores such as Google Play, Apple's App Store, Windows Store, and the like. At present there are over two million mobile applications available for download and the number of mobile applications is steadily on the rise. However, despite the growth of mobile application usage, it is estimated that less than one tenth of one percent of all mobile applications will become a financial success. One of the biggest factors in preventing a mobile application from being successful is the inability of consumers to discover the mobile application or information about the mobile application. Typically, a user discovers the mobile application by performing targeted searches within a search bar of an application store. However, given the large number of mobile applications available for download, standing out in an application store is becoming extremely difficult. For example, it is estimated that only a small fraction of mobile applications (less than 1%) are regularly provided as search results by an application store. Furthermore, the top spots in the search results are usually taken by mobile applications, and the developers thereof, that have made huge investments in advertisements.

In order for mobile application developers to get their mobile applications noticed, many rely on mobile advertising. Mobile ads can trigger users to download and install mobile applications with a single input or touch on the screen. Examples of mobile advertisements include banner ads, search ads, image ads, and the like. However, mobile advertisements can require significant cost often generated each time a user clicks on an advertisement regardless of whether the mobile application is downloaded and installed. More successful mobile applications may spend less on advertisements for each install (e.g., a cost per install of $3.00), however, the average mobile application may spend significantly more on advertising for each install (e.g., a cost per install of $20.00). Also, a mobile application is typically directed towards a core audience and provides a feature set that differentiates the mobile application from others. For example, a mobile application may solve a particular problem or provide a specific benefit to the core audience. However, connecting to that core audience through mobile advertising can be a difficult task.

### SUMMARY

According to an aspect of an example embodiment, provided is an application server that may include a network interface to receive, via the Internet, a request for payment of a rebate and proof of purchase of a product associated with the rebate via the mobile application executing on a mobile device, and a processor to determine whether the mobile application executing on the mobile device corresponds to a new user of the mobile application, and, in response to determining that the mobile application executing on the mobile device corresponds to a new user of the mobile application, authorize payment of the rebate to a payment account previously registered through the mobile application executing on the mobile device.

According to an aspect of another example embodiments, provided is a method for acquiring mobile application users, the method including providing a rebate offer with respect to a product, receiving, via the Internet, a request for payment of the rebate and proof of purchase of the product associated with the rebate via a mobile application executing on a mobile device, determining whether the mobile application executing on the mobile device corresponds to a new user of the mobile application, and, in response to determining that the mobile application executing on the mobile device corresponds to a new user of the mobile application, authorizing payment of the rebate to a payment account previously registered through the mobile application executing on the mobile device.

According to an aspect of another example embodiments, provided is a non-transitory computer readable medium having stored therein instructions that when executed cause an application server to perform a method for acquiring mobile application users, the method including receiving, via the Internet, a request for payment of a rebate and proof of purchase of a product associated with the rebate via a mobile application executing on a mobile device, determining whether the mobile application executing on the mobile device corresponds to a new user of the mobile application, and in response to determining that the mobile application executing on the mobile device corresponds to a new user of the mobile application, authorizing payment of the rebate to a payment account previously registered through the mobile application executing on the mobile device.

Other features and aspects will become apparent from the following detailed description when taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an example of a system for acquiring mobile application users in accordance with an example embodiment.

FIG. 2 is a diagram illustrating a mobile device capturing and uploading proof of purchase in accordance with an example embodiment.

FIGS. 3A-3G are diagrams illustrating examples of providing a rebate offer in accordance with example embodiments.

FIG. 4 is a diagram illustrating a method of acquiring mobile application users in accordance with an example embodiment.

FIG. 5 is a diagram illustrating a device for acquiring mobile application users in accordance with an example embodiment.

FIG. 6 is a diagram illustrating a user device in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The examples herein relate to a system, methods, and devices for acquiring new application users (e.g., mobile application users, web application users, etc.). As a non-limiting example, the application may be a money saving application that provides at least one of discounts, rewards, and promotional offers with respect to products available for purchase. According to various aspects, high value rebates for a product (e.g., an offer for a free product) may be associated with the product. As an example, the rebate offer may be incorporated into product packaging, and/or included in printed advertisements, digital advertisements, web advertisements, emails, and/or the like. The high value rebate offer may spark more consumer interest more than a typical coupon that only saves a consumer a fraction of the total cost of the product. In addition, the rebate offer may further include information about an application that must be downloaded, installed, and/or registered with, before a user can receive the rebate offer. In some cases, the rebate offer may further include instructions on how to download the application to a device such as a mobile device. When the user downloads the application to their device, the user may then register with an application server that controls the application and may become registered as a new user of the application. During initial install/registration of the application, or subsequent to the application being installed, payment account information of the user may be registered with the mobile application. For example, the payment account information may include a payment card (e.g., credit card, debit card, rewards card), a payment account or deposit account (e.g., PayPal), one-time gift card, and the like.

In order to receive the rebate, the device may be required to provide some form of proof that the product was purchased to the application server. For example, the device may capture an image or receive an image of a purchase receipt of the product confirming purchase of the product, and upload the image to the application server. In response, the application server may determine whether the application executing on the device corresponds to a new user of the application. For example, the application server may determine whether the device has previously registered for the application based on device identification information of the device. As another example, the application server may determine whether the application executing on the device corresponds to a new user of the application based on user information entered during a registration process. If the device corresponds to a new user of the application, the application server may authorize payment of the high value rebate such as the total cost of the product to the previously registered payment account of the user. Accordingly, the example embodiments may attract new users to an application based on high value rebate offers provided in association with products for sale. As a result, a provider of the application (e.g., developer, owner, creator, or the like) may not spend money advertising the application in order to find new users for the application. Furthermore, the provider may not need to fight for the application to be found during a search query by a user such as a search query through an application store. Instead, the provider can generate high value rebate offers, and require download of the application by a new user in order to receive the rebate.

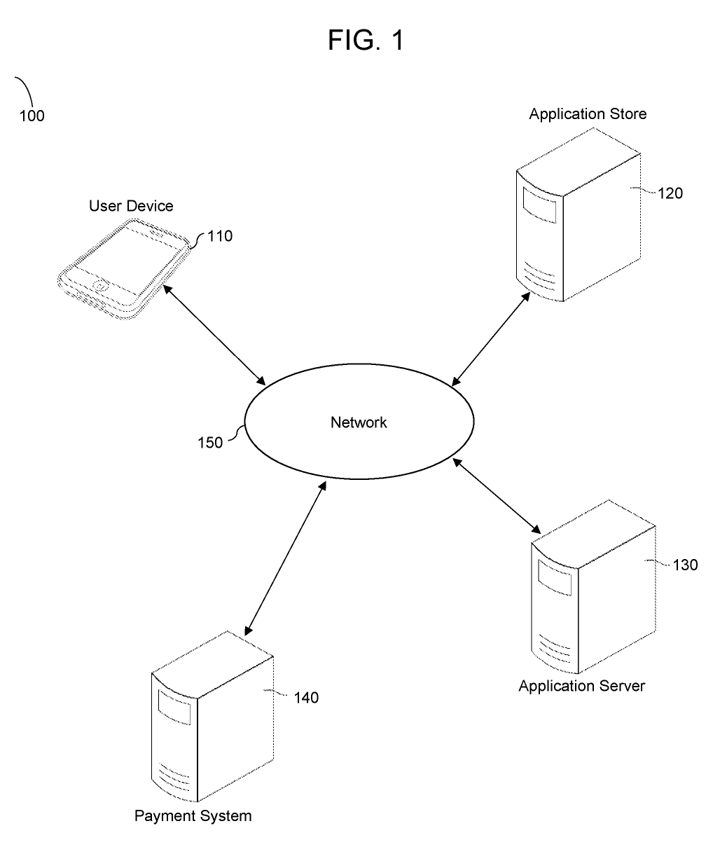

FIG. 1 illustrates an example of a system 100 for acquiring new mobile application users in accordance with an example embodiment. Referring to FIG. 1, the system 100 includes a plurality of devices that are connected to one another via a network 150. For example, the network 150 may be a public network such as the Internet, a private network, or a combination thereof. Also, the network 150 may be a wired network, a wireless network (e.g., cellular, radio), or a combination thereof. In this example, the system 100 includes a user device 110, an application store 120, an application server 130, and payment system 140 connected to each other through the network 150. It should also be appreciated that additional devices may be connected on the network 150. Also, the system 100 may not include one or more of the devices shown in FIG. 1.

The user device 110 may be a mobile device such as a mobile phone, a tablet, a phablet, a notebook, a notepad, a smart wearable device, and the like. As another example, the user device 110 may be a computer, a laptop, a server, and the like. The user device 110 may download and install applications also referred to herein as mobile applications or mobile apps. For example, the user device 110 may select an application for download from the application store server 120 and download and install the mobile application from the application store 120 and/or the application server 130. Here, the application store 120 (e.g., server) may have a widget (e.g., a displayed icon) stored on the user device 110 enabling the user device 110 to connect with the application store 120 and/or the application server 130 to perform the download. Examples of the application store 120 include Google Play, Apple's App Store, Windows Store, and the like.

Once installed, the mobile application may be executed on the user device 110, and be controlled by the application server 130. For example, the application server 130 may be a computing device designed to install, host, and operate mobile applications for end users such as user device 110. The mobile application hosted by the application server 130 may be used by multiple and simultaneously connected users. In this example, the application server 130 may include hardware and software that work together to provide computing-intensive operations and services to the residing application. The application server 130 may execute and provide the user device 110 access when utilizing the installed mobile application's business/functional logic. Also, the application server 130 may provide data redundancy, high availability, load balancing, user management, data/application security and a centralized management interface.

The payment system 140 may receive and process financial transactions. The payment system 140 may link bank accounts and provide for monetary exchange (e.g., online or electronic payments) using bank deposits. For example, the payment system 140 may include one or more devices corresponding to institutions, instruments, entities, standards, and technologies that make the monetary exchange possible including one or more of an issuing bank, an acquiring bank, payment gateway, a payment processor, and the like. The payment system 140 may receive requests from the application server 130 via the network 150. As another example, the payment system 140 may receive request directly from the application server 130 or a representative or agent thereof. The requests may include requests to pay funds from a payment account of the application server 130 to a payment account of a user of the user device 110.

According to various example embodiments, a rebate offer associated with a product may be provided with respect to the product, for example, on product packaging, via online advertisements, digital advertisements, print ads, and the like. A user of the user device 110 may collect various information from the rebate offer, including information about a mobile application to download and install in order to collect the offered rebate. For example, the rebate offer may include a link, an application name to be used in the application store, a web address, and the like, with which a user of the user device 110 may use to install and download the mobile application. For example, the user device 110 may connect to the application store 120 using the information included on the rebate offer. Based on the information from the rebate offer, the user device 110 may select and download the mobile application via the application store 120 over the network 150. The user device 110 may install the mobile application and a user of the user device 110 may register with the mobile application by inputting various user information such as address information, demographic information, payment account information, preference information, and the like.

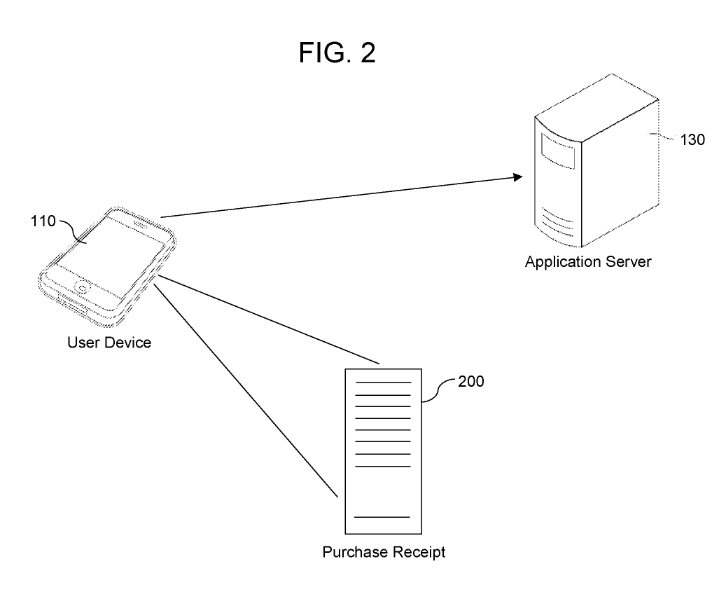

With the mobile application installed, the user device 110 may upload proof that the product associated with the rebate offer has been purchased to the application server 130. For example, FIG. 2 illustrates an example of the user device 110 capturing a picture of a purchase receipt 200 which in this example confirms purchase of the product. Here, the user device 110 may include a camera for capturing an image of the purchase receipt 200 and the image may be uploaded to the application server 130. As another example, the proof of purchase does not need to be an image file, but instead may be a text, email, SMS, and the like, identifying a product ID, a receipt, a coupon, and the like, of the product or purchase of the product. In addition to the proof of purchase, the application server 130 may receive a request for payment of the rebate via the mobile application executing on the user device 110. That is, the mobile application executing on the user device 110 may transmit a proof of purchase of the product along with a request for a rebate for the product to the application server 130.

According to various aspects, the application server 130 may determine whether to authorize payment of the rebate based on whether the mobile application executing on the user device 110 corresponds to a new user of the mobile application. As an example, the application server 130 may determine whether the mobile application executing on the user device 110 corresponds to a new user of the mobile application based on device information, user information, and the like. For example, the application server 130 may store an International Mobile Station Equipment Identity (IMEI) of the user device 110 during an installation process, user registration process, and the like. The application server 130 may store the IMEI in connection with an identifier of the mobile application. For example, the application server 130 may store a device token for each unique device that has installed the mobile application. The device token may identify the device via the IMEI or other device ID and may also identify the mobile application. The device token may be stored in a storage of the application server 130 or connect to the application server 130. For example, when the user device 110 installs the mobile application, registers with the mobile application through the application server 130, requests the rebate, and the like, the application server 130 may perform a check of the storage to determine whether there is already a stored device token for the user device 110 in association with the mobile application. If so, the application server 130 may determine that this is not a new user of the mobile application, however, if no device token exists, the application server 130 may determine that the user device 110 corresponds to a new user of the mobile application. In some examples, the installation and registration processes of the mobile application on the user device 110 may occur simultaneously. In addition, the request for rebate may also be performed simultaneously with the installation and registration processes. In some cases, the application server 130 may simultaneously receive the installation information, registration information, rebate request, and proof of purchase of the product.

As another example, the application server 130 may determine whether the mobile application executing on the user device 110 corresponds to a new user based on whether an identifier of the mobile application has been previously written to a secure storage of the user device 110. For example, during installation of the mobile application, the application server may store information in a secure storage of the user device 110 indicating that this is the first time the mobile application has been installed, or indicating that the mobile application has been previously installed. As another example, the application server 130 may determine whether the mobile application executing on the user device corresponds to a new user based on a username or other personal identifier of the user of the mobile application that is generated during the registration process.

As another example, the application server 130 may determine whether the mobile application executing on the user device corresponds to a new user based on payment account information registered by the user. For example, the user of the user device 110 may register a payment account such as a payment card, PayPal account, and the like, in order to receive payments from the mobile application. The payment account information may be used to determine if a previous user has ever had the same payment account information. Furthermore, the mobile application may provide instant rebates to a user through a real-time payment account such as PayPal. In some examples, the embodiments allow for multiple accounts to be on a single device. The determination as to whether the user is a new user may be based on both a device ID and a payment account of the user. In this case, if the combination of the device ID and the payment account is unique, the user may be determined to be a new user.

As another example, the application server 120 may provide to user device 110 a piece of executable code (e.g., a JavaScript function) for execution on user device 110 that may report to the application server 120 whether the user device 110 has the application installed therein, or whether the user device 110 has ever had the application installed therein. As another example, the executable code may determine whether the user device 110 can handle a URL or URI scheme that is associated with the installable mobile application.

In addition to, or instead of determining whether the mobile application has been previously installed, the determination process may also include determining whether a rebate has been previously received from the mobile application executing on the user device 110. The determining of whether a rebate has been previously received may be based on device information, user information, and the like, compared to information previously stored by the application server 130. Therefore, the mobile application may be installed by the user device 110 at a first time, and the rebate may be requested at a later time as long as the mobile application executing on the user device 110 has not previously requested a rebate. Accordingly, it should be appreciated that the determination of whether the mobile application executing on the user device 110 corresponds to a new user of the mobile application may be performed at a subsequent and separate time from which the application is installed and/or which the user is registered with the application server 130.

In response to determining that the mobile application executing on the user device 110 corresponds to a new user of the mobile application, the application server 130 may authorize payment of the rebate through the payment system 140. For example, the application server 130 may authorize the payment system 140 to make payment of the rebate from a payment account of the application server 130 to a payment account that is registered through the mobile application executing on the user device 110. If, however, the mobile application executing on the user device 110 does not correspond to a new user of the mobile application, a smaller rebate offer for the same product may be provided, a rebate offer for a different product may be provided, no rebate may be provided, or the like.

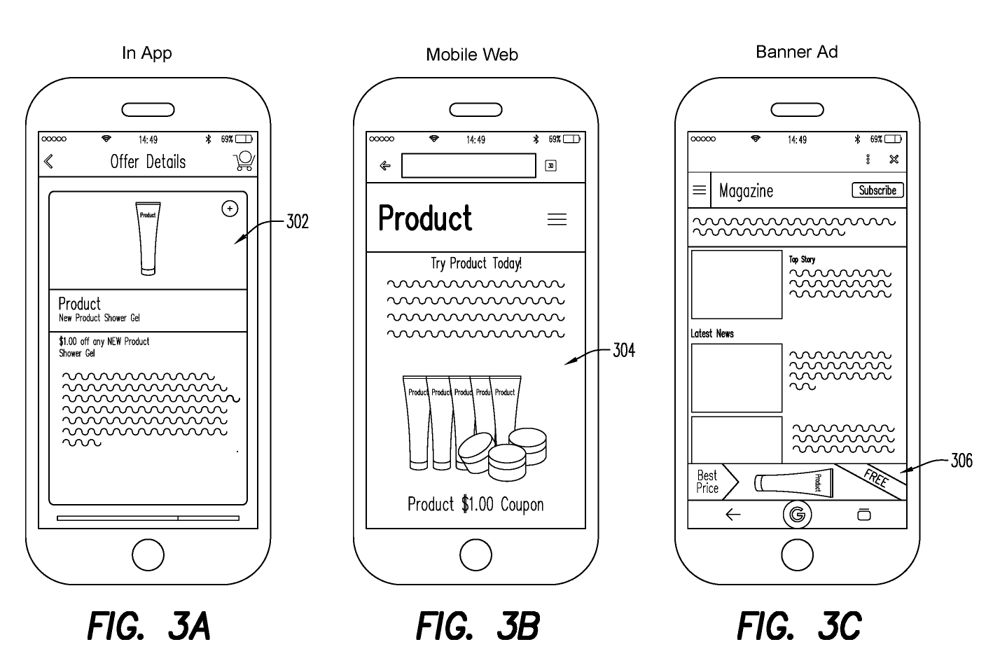

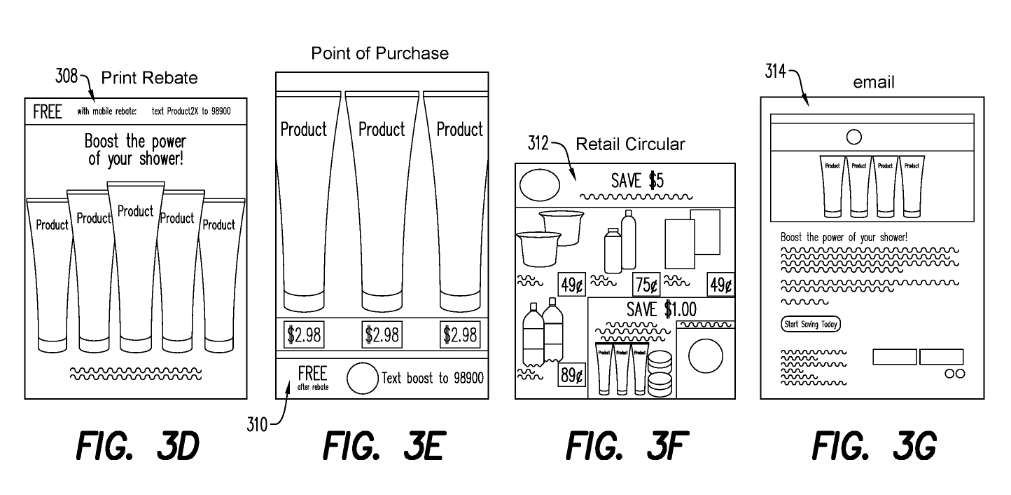

FIGS. 3A-3B illustrate examples of providing a rebate offer associated with a product according to various example embodiments. Referring to FIG. 3A, the rebate offer may be provided within a view or a screen of a mobile application 302, through a mobile website 304 viewed through a mobile browser, and through a banner advertisement 306 on a mobile website. In these examples, the rebate offer is a digital rebate offer being displayed by a user device such as user device 110 in FIG. 1. In this example, the digital ad or website may include a link which when selected by the user of the user device automatically opens an application store on the user device at a page corresponding to a download/install page of the mobile application. Accordingly, by selecting the link in any of the mobile application 302, the mobile website 304, or the banner advertisement 306, the user device may automatically open the application store and provide a user the option to download and install the corresponding mobile application.

Referring to FIG. 3B, the rebate offer may be provided in printed form such as in an advertisement printed in a magazine or newspaper 308 or a retail circular 312. As another example, the rebate offer may be provided on product packaging 310. As yet another example, the rebate offer may be provided via an email or text message 314. In these examples, the rebate offer may include instructions on how to download the mobile application and to receive the rebate for the associated product. As an example, the printed or emailed rebate offer may include a code and a phone number to dial or to text in order to send the code (e.g., “Text ‘PRODUCT NAME’ to 12345 to download mobile app and get this product for free”).

According to various embodiments, the mobile application described herein may be a product savings mobile application that provides coupons, rebates, promotional offers, brand awareness, and the like, to its users. That is, the mobile application may be directed towards saving money. As will be appreciated, a user that is interested in a mobile application that can save them money will likely also be interested in receiving a full rebate for a purchased product, especially when all they need to do is download and install a new mobile application. Accordingly, the high value rebate offer may attract the kind of users that would be interested in a money saving mobile application. As a result, the system and method herein may acquire a core audience of users to the mobile application.

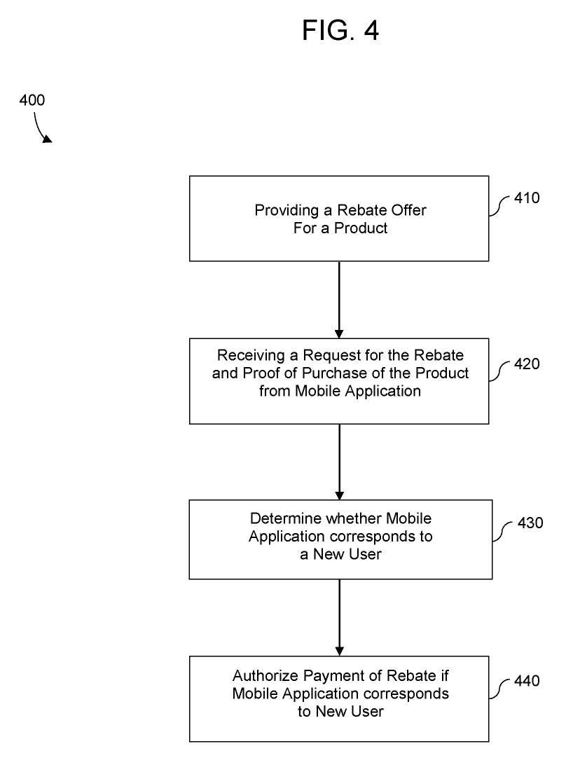

FIG. 4 illustrates a method 400 of acquiring mobile application users in accordance with an example embodiment. As an example, the method 400 of FIG. 4 may be performed by a web server such as application server 130 shown in FIG. 1, however, the example embodiments herein are not limited thereto. Referring to FIG. 4, the method 400 may include providing a rebate offer in associate with a product, in 410. As another example, step 410 may be omitted or may be performed by someone or something else.

According to various aspects, the rebate offer may be provided in association with a digital advertisement, an on-package advertisement, an email, a print advertisement, and the like. According to various examples herein, the rebate offer may be for a full refund of the cost of the product, or some other high value rebate offer, on condition that a consumer download and install a mobile application or web application to their device. In response to viewing the rebate offer, a user of a computing device may download and install the mobile application. During installation, the user may register with the application server providing the mobile application. In addition, the user may submit a request for a rebate along with proof of purchase of the product. As another example, the user may submit the request for the rebate along with the proof of purchase at a separate subsequent point of time from the install and registration of the mobile application. In 420, the application server receives the request for the rebate and the proof of purchase of the product from the mobile application executing on the mobile device.

In 430, the application server determines whether the mobile application executing on the mobile device corresponds to a new user of the mobile application. For example, the application server may determine whether the mobile application has never been installed on the mobile device based on a device ID such as a SIM card, an IMEI, UDID, ESN, MEID, IMSI, MAC address, serial number, and the like. As another example, the application server may check a secure storage of the mobile device to determine if an identifier of the mobile application was previously stored in the secure storage thereby indicating if the mobile application was previously installed. The application server may further determine whether the mobile application executing on the mobile device has previously requested a rebate of any kind from the application server. For example, if the mobile application has never been installed and if the mobile application has never requested a rebate, the application server may determine that the mobile application executing on the mobile device corresponds to a new user of the mobile application. As another example, the mobile application may be determined to be newly installed if the mobile application is determined to have never requested a rebate regardless of whether the mobile application was previously installed or even if the mobile application was determined to be previously installed.

In response to determining that the mobile application executing on the mobile device corresponds to a new user of the mobile application, in 440, the method includes authorizing payment of the rebate to a payment account previously registered through the mobile application executing on the mobile device or otherwise previously established for the user of the mobile device. For example, the application server may authorize payment system 140 shown in FIG. 1 to make payment from an account of the mobile application provider to an account of the user of the mobile application. The payment of the rebate may occur immediately when the request is received from the mobile application executing on the mobile device, for example, by transferring the money to a PayPal account associated with the user, and the like.

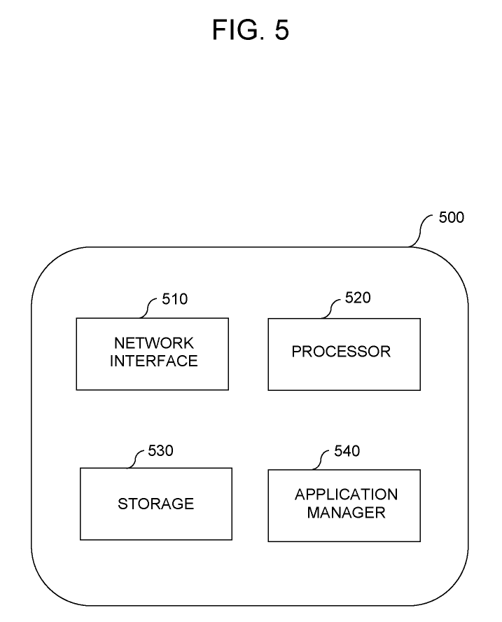

FIG. 5 illustrates a device 500 for acquiring users in accordance with an example embodiment. The device 500 may correspond to the application server 130 shown in FIG. 1, or another device or combination of devices. Also, the device 500 may perform the method 400 shown in FIG. 4. Referring to FIG. 5, the device 500 includes a network interface 510, a processor 520, a storage 530, and an application manager 540. The network interface 510 may transmit and receive data over a network such as the Internet and/or a private network. The processor 520 may control the overall operations of the device 500 and may include hardware for performing the operations of the application server described herein. The device 500 also includes the application manager 540 which controls the installation, registration process, and execution of mobile applications on user devices. For example, the application manager 540 may handle application operations between users and the mobile application backend and/or databases (e.g., storage 530). The storage 530 may store information about mobile devices (e.g., device ID's), information about users of mobile applications, and the like. Also, the storage 530 may store device tokens for each mobile device that downloads and installs the mobile application. The device token may identify the device by device ID and identify the mobile application that was installed on the device.

The network interface 510 may receive, via the Internet, a request for payment of a rebate and proof of purchase of a product associated with the rebate from a mobile application executing on a user device. For example, the proof of purchase may include an image file of a receipt, a code, a password or PIN number, and the like. In response, the processor 520 may determine whether the mobile application executing on the mobile device corresponds to a new user of the mobile application using any of the previously described methods or other methods known in the art. In response to determining that the mobile application executing on the mobile device corresponds to a new user of the mobile application, the processor 520 may authorize payment of the rebate to a payment account previously registered through the mobile application executing on the mobile device.

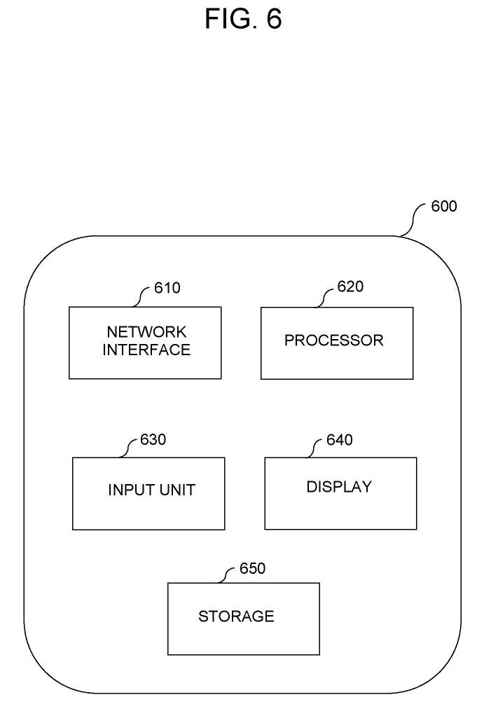

FIG. 6 illustrates a user device 600 in accordance with an example embodiment. The user device 600 may correspond to the user device 110 shown in FIG. 1, and may perform any of the actions or operations previously described therewith. For example, the user device 600 may be a mobile device, a tablet, a computer, a laptop computer, a notebook computer, a smart wearable device, a kiosk, a television, an appliance, and the like. Referring to FIG. 6, the user device 600 includes a network interface 610, a processor 620, an input unit 630, a display 640, and a storage 650. The network interface 610 may transmit and receive data over a network such as the Internet and/or a private network. The processor 620 may include a single core processing device, a multicore processing device, or multiple processing devices. The processor 620 may control the overall operations of the user device 600. The input unit 630 may include one or more of a keyboard, a mouse, a touchpad, a voice recognition module, a motion recognition module, and the like. The display 640 may be an embedded display such as a touch screen on a mobile device or it may be an external display attached to the computing device through a connection such as a wired or wireless connection. The storage 650 may include any desired memory, for example, random access memory (RAM), one or more hard disks, cache, hybrid memory, an external memory, flash memory, and the like. Although not shown in FIG. 6, the user device 600 may include other features not shown, or one or more of the features may be omitted.

According to various aspects, the user device 600 may download and install mobile applications through an application store. For example, the mobile application may be received via the network interface 610 and may be installed by the processor 620 in response to commands input by a user through the input unit 630. The installation of the mobile application and registration with the mobile application may also be performed with an application server corresponding to the mobile application. While the mobile application is executing on the user device 600, the user may register a payment account with the application server through the mobile application. Also, the user may upload the image of the proof of purchase to the application server via the network interface 610 under the control of the processor 620.

According to various aspects, as another example, the user may perform a scan or capture an image of a purchase receipt and based on the purchase receipt, a second high value rebate offer could be provided in addition to the original high value rebate offer. For example, an immediate second rebate offer (or series of offers) could be provided by the system based on a projected loan-to-value (LTV) ratio of the customer that may be inferred based on one or more internal and external factors including the total cost of all items on the purchase receipt in addition to the item associated with the first rebate, SKUs of the other products on the receipt, consumer demographics, store of purchase, and the like.

In some aspects, near-field communication (NFC) or radio frequency identifier (RFID) technology may be incorporated within the system. For example, NFC or RFID technology may be placed on product packaging and may interact with a product savings mobile application on a user device described in the exemplary embodiments. For example, the mobile application may provide a gamification approach in which a user receives a message indicating there is a free product (or some other high value rebate) somewhere in the store causing the consumer to walk down various isles in the store until they get close enough to the free product. In this example, only when the user is close enough to the product is the user notified which product is free. In doing so, the user will also walk by a number of other products within the store, thus promoting brand awareness.

As another example, a variable offer may be provided to a user based on accumulated data triggered by an in-isle scan of a bar code for a promoted item. As an example, a promotion may be placed on a package of cheese. In this case, the mobile application may determine from crowdsourcing data that the user of the mobile application is a regular cheese buyer and a crackers buyer. In this example, selected buyers such as this user that is inclined to purchase cheese and crackers (i.e., the publicly promoted good) may be privately, selectively and dynamically offered a similar promotion on another good or goods based on purchase patterns and history.

As another example, the mobile application may leverage physical collateral. For example, the user of the mobile application may bring into a store an issue of magazine which has displayed a high value rebate offer on a selected good. While in isle, the user of the mobile application may capture a picture of the ad in-app which activates the offer in the app.” In this example, the user device may send geo location information to the mobile application server to affirm that the user is at an in-store location.

As another example, when a user is leaving a store, a leaving the store notification filtered by client type may be provided. For example, the leaving the store notification may be defined by shopping patterns and may say something such as “Don't leave the store without your free product X.”

According to various example embodiments, described herein is a system and method for acquiring new users for a mobile application. The average mobile application (or developer thereof) may spend a significant amount of money on advertising resulting in a very high cost per install of their mobile application (e.g., a cost per install of $20.00). According to various aspects, the cost per install of a mobile application can be reduced to the cost of a product for sale (e.g., a cost per install of $2.00, $3.00, $4.00, and the like). That is, by providing free rebates or other high value rebates for products only after the mobile application has been downloaded and installed, a provider of the mobile application can acquire new users without incurring the significant expense of advertising the mobile application. Furthermore, the provider does not need to worry about whether the mobile application is popular with application store search engines. The example embodiments also benefit the manufacturers of the product, because they are paid for the product regardless of whether the consumer registers for the mobile application or not. In addition, the examples herein promote brand awareness of the product.

As used herein, the term account or payment account may refer to a card, transaction card, financial transaction card, payment card, and the like, refer to any suitable transaction card, such as a credit card, a debit card, a prepaid card, a charge card, a membership card, a promotional card, a frequent flyer card, an identification card, a gift card, and the like, and also refer to any suitable payment account such as a deposit account, bank account, credit account, and the like. As another example, the terms may refer to any other device or media that may hold payment account information, such as mobile phones, Smartphones, personal digital assistants (PDAs), key fobs, computers, and the like. The transaction card can be used as a method of payment for performing a transaction.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the invention as set forth in the appended claims.

What is claimed is:

1. An application server comprising:
a network interface configured to receive, via the Internet, a request for payment of a rebate and proof of purchase of a product associated with the rebate via the mobile application executing on a mobile device; and
a processor configured to determine whether the mobile application executing on the mobile device corresponds to a new user of the mobile application, and, in response to determining that the mobile application executing on the mobile device corresponds to a new user of the mobile application, authorize payment of the rebate to a payment account previously registered through the mobile application executing on the mobile device.

2. The application server of claim 1, wherein the processor is configured to determine whether the mobile application executing on the mobile device corresponds to a new user based on an International Mobile Station Equipment Identity (IMEI) of the mobile device.

3. The application server of claim 2, wherein the processor determines that the mobile application executing on the mobile device corresponds to a new user when the IMEI of the mobile device has not been previously stored by the application server in association with an identifier of the mobile application, and
the processor determines that the mobile application executing on the mobile device does not correspond to a new user when the IMEI of the mobile device has been previously stored by the application server in association with the identifier of the mobile application.

4. The application server of claim 2, the processor is configured to determine whether the mobile application executing on the mobile device corresponds to a new user based on whether an identifier of the mobile application has been previously written to a secure storage of the mobile device.

5. The application server of claim 1, wherein the processor is configured to determine whether the mobile application executing on the mobile device corresponds to a new user based on an identifier of a user of the mobile application executing on the mobile device.

6. The application server of claim 1, wherein the proof of purchase received from the mobile application comprises an image file including a picture of a purchase receipt.

7. A method for acquiring mobile application users, the method comprising:
providing a rebate offer with respect to a product;
receiving, by an application server via the Internet, a request for payment of the rebate and proof of purchase of the product associated with the rebate via a mobile application executing on a mobile device;
determining, by the application server, whether the mobile application executing on the mobile device corresponds to a new user of the mobile application; and
in response to determining that the mobile application executing on the mobile device corresponds to a new user of the mobile application, authorizing, by the application server, payment of the rebate to a payment account previously registered through the mobile application executing on the mobile device.

8. The method of claim 7, wherein the determining comprises:
determining whether the mobile application executing on the mobile device corresponds to a new user based on an International Mobile Station Equipment Identity (IMEI) of the mobile device.

9. The method of claim 8, wherein the determining further comprises:
determining that the mobile application executing on the mobile device corresponds to a new user when the IMEI of the mobile device has not been previously stored by the application server in association with an identifier of the mobile application, and
determining that the mobile application executing on the mobile device does not correspond to a new user when the IMEI of the mobile device has been previously stored by the application server in association with the identifier of the mobile application.

10. The method of claim 7, wherein the determining comprises:
determining whether the mobile application executing on the mobile device corresponds to a new user based on whether an identifier of the mobile application has been previously written to a secure storage of the mobile device.

11. The method of claim 7, wherein the determining comprises:
determining whether the mobile application executing on the mobile device corresponds to a new user based on an identifier of a user of the mobile application executing on the mobile device.

12. The method of claim 7, wherein the proof of purchase received from the mobile application comprises an image file including a picture of a purchase receipt.

13. The method of claim 7, wherein the providing the rebate offer comprises printing the offer on packaging of the product.

14. The method of claim 7, wherein the providing the rebate offer comprises displaying the rebate offer on at least one of a website, a banner, an email, and through the mobile application.

15. A non-transitory computer readable medium having stored therein instructions that when executed cause an application server to perform a method for acquiring mobile application users, the method comprising:
receiving, by the application server via the Internet, a request for payment of a rebate and proof of purchase of a product associated with the rebate via a mobile application executing on a mobile device;
determining, by the application server, whether the mobile application executing on the mobile device corresponds to a new user of the mobile application; and
in response to determining that the mobile application executing on the mobile device corresponds to a new user of the mobile application, authorizing, by the application server, payment of the rebate to a payment account previously registered through the mobile application executing on the mobile device.

16. The non-transitory computer readable medium of claim 15, wherein the determining comprises:
determining whether the mobile application executing on the mobile device corresponds to a new user based on an International Mobile Station Equipment Identity (IMEI) of the mobile device.

17. The non-transitory computer readable medium of claim 16, wherein the determining further comprises:
determining that the mobile application executing on the mobile device corresponds to a new user when the IMEI of the mobile device has not been previously stored by the application server in association with an identifier of the mobile application, and
determining that the mobile application executing on the mobile device does not correspond to a new user when the IMEI of the mobile device has been previously stored by the application server in association with the identifier of the mobile application.

18. The non-transitory computer readable medium of claim 15, wherein the determining comprises:
determining whether the mobile application executing on the mobile device corresponds to a new user based on whether an identifier of the mobile application has been previously written to a secure storage of the mobile device.

19. The non-transitory computer readable medium of claim 15, wherein the determining comprises:
determining whether the mobile application executing on the mobile device corresponds to a new user based on an identifier of a user of the mobile application executing on the mobile device.

20. The non-transitory computer readable medium of claim 15, wherein the proof of purchase received from the mobile application comprises an image file including a picture of a purchase receipt.
